(19) United States
(12) Patent Application Publication
(10) Pub. No.: US 2013/0323153 A1
(43) Pub. Date: Dec. 5, 2013

(54) SILICON SINGLE CRYSTAL WAFER

(71) Applicants: Ryoji Hoshi, Nishishirakawa (JP); Suguru Matsumoto, Nishishirakawa (JP); Hiroyuki Kamada, Nishishirakawa (JP); Kosei Sugawara, Nishishirakawa (JP)

(72) Inventors: Ryoji Hoshi, Nishishirakawa (JP); Suguru Matsumoto, Nishishirakawa (JP); Hiroyuki Kamada, Nishishirakawa (JP); Kosei Sugawara, Nishishirakawa (JP)

(73) Assignee: SHIN-ETSU HANDOTAI CO., LTD., Tokyo (JP)

(21) Appl. No.: 13/985,756

(22) PCT Filed: Feb. 15, 2012
(86) PCT No.: PCT/JP2012/000977

§ 371 Date: Aug. 15, 2013

(30) Foreign Application Priority Data
Mar. 8, 2011 (JP) 2011 050394

(51) Int. Cl. C01B 33/02

(52) U.S. Cl. CPC C01B 33/02
USPC 423/348

(57) ABSTRACT

The present invention provides a silicon single crystal wafer sliced out from a silicon single crystal ingot grown by a Czochralski method, wherein the silicon single crystal wafer is sliced out from the silicon single crystal ingot having oxygen concentration of 8×10¹⁷ atoms/cm³ (ASTM' 79) or less and includes of a defect region where neither FPDs nor LEPs are detected by preferential etching but LSTDs are detected by an infrared scattering method. As a result, the wafer having the low oxygen concentration can be provided at low cost without causing a breakdown voltage failure or a leak failure at the time of fabricating a device.

### TECHNICAL FIELD

The present invention relates to a defect-controlled silicon single crystal wafer with low oxygen concentration used in the leading-edge field in particular.

### BACKGROUND ART

In recent years, power devices attract attention in relation to energy saving. These devices are different from other devices such as a memory, and a large current flows though their wafer. A region through which a current flows is not restricted to a top surface layer as different from conventional examples, and a current may flow through the range with a thickness of tens or hundreds of μm from the surface layer or may flow in a thickness direction depending on a device.

When a crystal defect or a BMD (Bulk Micro Defect, which will be also referred to as an oxide precipitate hereinafter) which is produced when oxygen precipitates is present in such a region where a current flows, a problem of a breakdown voltage or leak may possibly occur. Therefore, there has been used a wafer that has less crystal defects and contains no oxygen, e.g., an epitaxial wafer having an epitaxial layer laminated on a wafer that serves as a substrate or a wafer manufactured by an FZ method (Floating Zone Method: a floating zone melting method).

However, respective wafers have problems. For example, an epitaxial wafer is expensive, or further increasing a diameter of FZ crystal is difficult. Thus, there is adopted a wafer fabricated from crystal grown by a Czochralski method (Czochralski Method) whose cost is relatively low and diameter can be relatively easily increased.

The CZ crystal is generally grown from a silicon raw material (a silicon melt) molten in a quartz crucible. At this time, oxygen is eluted from the quartz crucible. A greater part of the eluted oxygen is evaporated, but part of it reaches to a portion immediately below a crystal growth interface through the silicon melt, and hence grown silicon single crystal contains oxygen.

The oxygen contained in the silicon single crystal moves and agglomerates to form BMDs by a heat treatment given in device fabrication and others. As described above, when the BMDs are formed, the problems of leak or a breakdown voltage may possibly occur. Since occurrence of the BMDs can be suppressed when the oxygen concentration is lowered, the low oxygen concentration is required as quality. As oxygen concentration reducing technology for crystal, Patent Literature 1 discloses that oxygen concentration can be greatly reduced to 2×10¹⁷ (atoms/cm³) by decreasing a rate of rotating crystal or rotating a crucible by an MCZ method (a magnetic field applying Czochralski method).

Further, there is known that crystal defects formed during crystal growth are present in CZ crystal. Silicon single crystal usually contains each vacancy and interstitial Si which are an intrinsic point defect. Saturation concentration of this intrinsic point defect is a function of a temperature, and a supersaturation state of the point defect occurs with a precipitous reduction in temperature during crystal growth. The supersaturated point defect is going to alleviate the supersaturation state by, e.g., pair annihilation or out diffusion/slope diffusion. However, in general, this supersaturation state cannot be completely eliminated, and one of the vacancy or the interstitial Si remains as a dominant supersaturation point defect. It is known that a vacancy excess state is apt to be realized when a crystal growth rate is high, and an interstitial Si excess state is apt to be realized when the crystal growth rate is low. When this excess concentration exceeds a certain level, these point defects and agglomerate, whereby a crystal defect is formed during the crystal growth.

As a crystal defect that is formed in a region where the vacancy is dominant (a V region), an OSF nucleus or a void is known. The OSF nucleus is a defect that is observed as a stacking fault when a crystal sample is subjected to a heat treatment in a wet oxidizing atmosphere at a high temperature of approximately 1100° C. to 1150° C., Si is thereby implanted from a surface, a stacking fault (SF) grows around an OSF nucleus, and preferential etching is carried out while shaking the sample in a selective etchant.

A void is a cavity defect formed when vacancies agglomerate, and it is known that an oxide film called an inner wall oxide film is formed on an inner wall. In regard to this defect, there are several names depending on how this defect is detected. When a laser beam is applied to a wafer surface and observation is carried out using a particle counter that detects reflected light/scattered light or the like, the defect is called a COP (Crystal Originated Particle). When a sample is left in a preferential etchant for a relatively long time without shaking and then a defect is observed as a flow pattern, this defect is called an FPD (Flow Pattern Defect). When an infrared laser beam incidents on a surface of a wafer and a defect is observed by an infrared scattering tomograph (LST: Laser Scattering Tomography) that detects scattered light, the defect is called an LSTD (Laser Scattering Tomography Defect). Although these detection methods are different from each other, the defects are all considered as voids.

On the other hand, in a region where the interstitial Si is dominant (an I region), a crystal defect obtained by agglomeration of Interstitial Si is formed. Although identity of this defect is not clear, it is considered as a dislocation loop or the like, and a massive one is observed as a dislocation loop cluster by TEM (Transmission Electron Microscopy). A secondary defect of this interstitial Si is observed as a large pit by the same etching method as the FPD, namely, by leaving a sample in a preferential etchant for a relatively long time without shaking. This is called an LEP (Large Etch Pit) or the like.

As described above, when the above-described crystal defects are formed, the problem of leak or a breakdown voltage may possibly occur. Patent Literature 2, 3 or the like discloses technology that manufactures crystal having no such crystal defects. According to defect-free crystal manufacturing technology, to reduce concentration of excess point defects with no limit, V/G represented by a crystal growth rate V and a temperature gradient G near a growth interface is controlled to an extremely restricted narrow range, thereby obtaining a desired defect region.

Since the crystal growth rate V does not basically vary in a radial direction of crystal, to obtain a defect-free region within an entire wafer plane, reducing unevenness of G in the crystal radial direction is important. These values are often obtained by performing simulation using a computer in advance. However, experiment data as a base is required at the time of calculation. This base data is acquired by checking a G distribution in the crystal radial direction by experiment.

As an experimental method for grasping the G distribution in the crystal radial direction, the following method is often used.

First, crystal whose growth rate is intentionally changed in a length direction (a longitudinal direction) is grown. The grown crystal is sliced in the same longitudinal direction as a growth axis, and a sample is thereby prepared. This sample is subjected to an oxygen precipitation heat treatment, thus grasping a defect distribution. FIG. 16 shows results obtained by performing the oxygen precipitation heat treatment to a sample obtained by slicing a crystal, which was actually grown while changing its growth rate under conditions aiming at defect-free crystal, in the longitudinal direction and observing it by an X-ray topograph. As shown in FIG. 16, more or less oxygen precipitation appears as shade so that a crystal defect region can be clearly recognized. The crystal growth conditions are adjusted together with calculation based on simulation so that this defect distribution can be unchanged in both a crystal central portion and a peripheral portion. Based on such a method, crystal having no defect in the entire wafer plane can be obtained.

However, since oxygen precipitation does not occur in low-oxygen concentration crystal in the first place, the defect distribution cannot be grasped by using the above-described method. Since the defect distribution varies depending on mainly a heat environment that is received by crystal to be grown, it is possible to grasp the defect distribution by increasing oxygen concentration alone under conditions where the heat environment is unchanged. However, when the oxygen concentration alone is lowered to grow crystal in a state where defect-free crystal can be formed at high oxygen concentration, the defect-free crystal cannot be actually obtained. It can be considered that such a matter occurred that the defect distribution is sensitive to not only the heat environment but also a change in crystal growth interface caused due to a convection current or the like in the melt. To realize the low oxygen concentration, as disclosed in Patent Literature 1, a magnetic field must be applied, or a crystal rotating rate or a crucible rotating rate must be reduced. These actions greatly change a melt convection current, and it can be considered that the defect distribution changes with realization of the low-oxygen concentration as a matter of course.

Therefore, in manufacture of the low oxygen concentration crystal, finding out conditions for growing defect-free crystal is very difficult.

Furthermore, as technology that suppresses an influence of defects even though a defect-free state is not achieved, Patent Literature 4 discloses technology that minimizes a size of generated defects and thereby suppresses an influence of defects.

The technology disclosed in Patent Literature 4 is technology that greatly minimizes a crystal defect size by preventing each crystal defect from growing based on rapid cooling of crystal and using a region with a low vacancy supersaturation degree that is present in a vacancy-rich region having a higher growth rate than a defect-free region. However, even in crystal manufactured by this method, FPDs are detected in at least a regular oxygen concentration region, and a breakdown voltage may be possibly deteriorated when a device is fabricated.

Moreover, Patent Literature 5 discloses technology that is a combination of such a method for decreasing a defect size and realization of low-oxygen concentration.

In Patent Literature 5, a region where a defect size is 100 nm or less and defect density is 3×10⁶ (/cm³) or less is defined. In the low oxygen concentration crystal, since grasping the above-described defect distribution is difficult, limiting crystal growth conditions to the above-described region was attempted, but this limitation is actually very difficult. Additionally, according to this technology, its gist is to maintain a small crystal defect size, perform annealing, and eliminate defects even in a wafer, and there is a problem that a manufacturing cost increases since a heat treatment is required.

As technology that can solve such problems, Patent Literature 6 discloses technology of a low oxygen single crystal wafer in which dislocation clusters and void defects are eliminated by doping nitrogen. However, this method still has a problem that productivity is low since a growth rate is relatively slow, and a donor due to nitrogen is generated since nitrogen is doped.

### CITATION LIST

### Patent Literatures

Patent Literature 1: Japanese Unexamined Patent Publication (Kokai) No. H5-155682
Patent Literature 2: Japanese Unexamined Patent Publication (Kokai) No. H11-147786
Patent Literature 3: Japanese Unexamined Patent Publication (Kokai) No. 2000-1391
Patent Literature 4: Japanese Unexamined Patent Publication (Kokai) No. 2001-278692
Patent Literature 5: Japanese Unexamined Patent Publication (Kokai) No. 2010-202414
Patent Literature 6: Japanese Unexamined Patent Publication (Kokai) No. 2001-146498

### SUMMARY OF THE INVENTION

### Problem to be Solved by the Invention

In view of the above-described problem, it is an object of the present invention to provide a wafer having low oxygen concentration at low cost without causing a breakdown voltage failure or a leak failure at the time of fabricating a device.

### Means for Solving Problem

To achieve this aim, according to the present invention, there is provided a silicon single crystal wafer sliced out from a silicon single crystal ingot grown by a Czochralski method, wherein the silicon single crystal wafer is sliced out from the silicon single crystal ingot having oxygen concentration of 8×10′⁷ atoms/cm³ (ASTM' 79) or less and comprises a defect region where neither FPDs nor LEPs are detected by preferential etching but LSTDs are detected by an infrared scattering method.

Such a wafer can be manufactured with good productivity, and a failure of, e.g., a breakdown voltage or leak does not occur even if a device is fabricated. Therefore, a yield ratio of device fabrication can be improved, and the high-quality silicon single crystal wafer can be provided at low cost.

At this time, it is preferable that the silicon single crystal wafer consists of: a defect region where neither FPDs nor LEPs are detected by the preferential etching but LSTDs are detected by the infrared scattering method; and a defect-free region where LSTDs are not detected by the infrared scattering method.

When such a defect region is provided, the wafer that does not include a defect that affects a device can be manufactured with higher productivity, and the high-quality wafer can be provided at lower cost.

At this time, it is preferable that the silicon single crystal wafer is sliced out from the silicon single crystal ingot having oxygen concentration of 5×10¹⁷ atoms/cm³ (ASTM' 79) or less.

When such oxygen concentration is obtained, a margin for providing the defect region according to the present invention can be further expanded, an amount of oxygen donors generated by the heat treatment becomes an amount which does not affect resistivity, and hence the high-quality wafer can be provided at lower cost.

At this time, it is preferable that the silicon single crystal ingot contains nitrogen and oxygen in such a manner that nitrogen concentration [N] atoms/cm³ and the oxygen concentration [Oi] atoms/cm³ (ASTM' 79) meet [N]×[Oi]³≦3.5×10⁶⁷.

When nitrogen and oxygen are contained at such concentration, the resistivity is not affected, a margin for providing the defect region according to the present invention can be further expanded, and hence the high-quality wafer can be provided at lower cost.

### Advantageous Effects of the Invention

As described above, according to the present invention, device failures due to defects do not occur, and the high-quality silicon single crystal wafer can be provided at low cost.

### BRIEF DESCRIPTION OF THE DRAWINGS

FIG. 1 is a graph showing a relationship between FPDs and oxygen concentration examined in Experiment 2;

FIG. 2 is a graph showing a relationship between LSTDs and oxygen concentration examined in Experiment 2;

FIG. 3 is a view schematically showing a relationship between oxygen concentration and a defect region obtained in Experiment 3;

FIG. 4 is a graph showing a relationship between oxygen concentration and an mount of generated carriers due to an oxygen donor in a sample examined in Experiment 4;

FIG. 5 is a graph showing a relationship between a product of nitrogen concentration to the first power and oxygen concentration to the third power and an amount of generated carriers due to an NO donor examined in Experiment 5;

FIG. 6 is a schematic view of a single-crystal pulling apparatus;

FIG. 7 is a graph showing an oxygen concentration radial distribution in a sample according to Example 1;

FIG. 8 is a graph showing an LSTD radial distribution in the sample according to Example 1;

FIG. 9 is a graph showing an oxygen concentration radial distribution in a sample according to Example 2;

FIG. 10 is a graph showing an LSTD radial distribution in the sample according to Example 2;

FIG. 11 is a graph showing an FPD radial distribution in a sample according to Comparative Example;

FIG. 12 is a graph showing an oxygen concentration radial distribution in the sample according to Comparative Example;

FIG. 13 is a graph showing an LSTD radial distribution in the sample according to Comparative Example;

FIG. 14 is a graph showing an oxygen concentration radial distribution in a sample according to Example 3;

FIG. 15 is a graph showing an LSTD radial distribution in the sample according to Example 3; and

FIG. 16 is a view obtained by observing a defect region of crystal.

### BEST MODE FOR CARRYING OUT THE INVENTION

In case of manufacturing a defect-free wafer in which a device failure does not occur, there is a problem of productivity or the like, and hence the present inventors conducted the following experiments and keen examination.

### Experiment 1

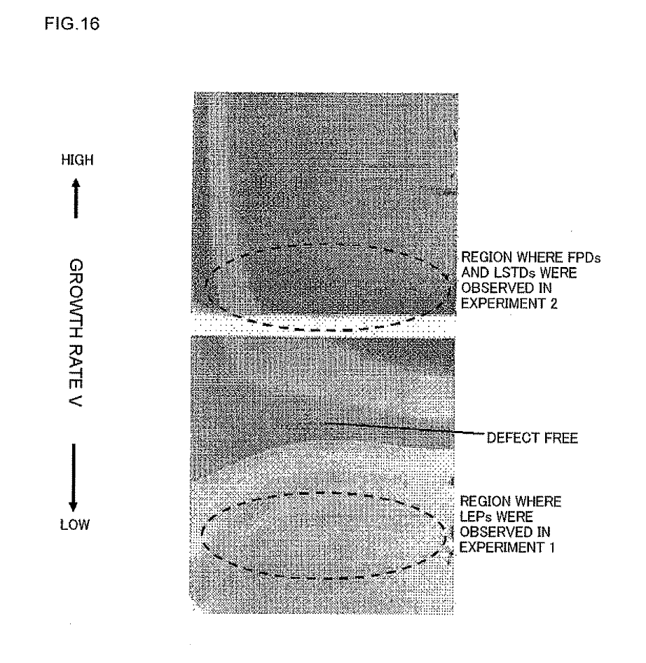

First, in a region where interstitial Si is dominant, each crystal was grown under each condition that oxygen concentration was designated at a growth rate lower than that in a defect-free region shown in FIG. 16, a wafer-like sample was sliced out from each crystal, and LEPs were evaluated.

In the LEP evaluation, each wafer-shaped sample was subjected to surface grinding, cleaning, mirror etching adopting a mixed acid, then the sample was left in an etching solution with selectivity consisting of a hydrofluoric acid, a nitric acid, an acetic acid, and water without shaking, it was left until an etching removal reaches 25±3 μm on both sides, and then counting was effected using an optical microscope. As a result, oxygen concentration dependence was not observed in the number of observed LEPs.

### Experiment 2

As Experiment 2, FPDs and LSTDs of each crystal grown in a region where vacancies are dominant were observed. The observed crystal region was a defect region where a growth rate is high and OSF nuclei are considered to adhere to the outer periphery of each crystal in a defect chart in FIG. 16, and each crystal was grown under each condition that oxygen concentration was designated. A wafer-shaped sample was sliced out from each crystal, and FPD evaluation was carried out.

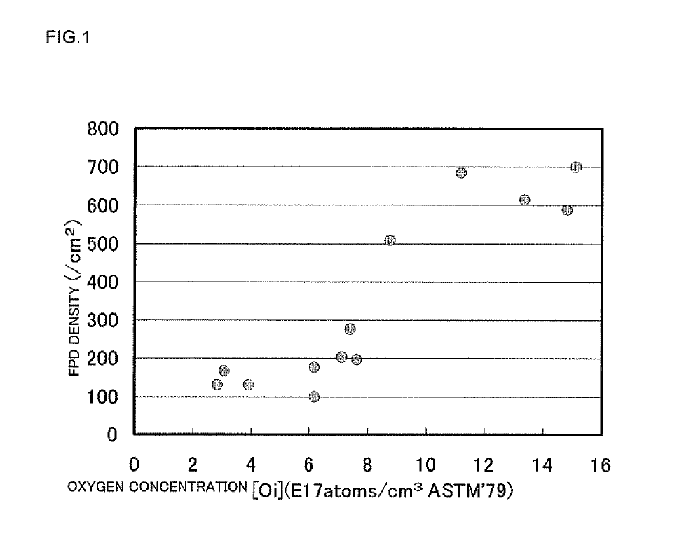

The FPD evaluation was conducted under the same conditions as those of the LEP evaluation in Experiment 1. FIG. 1 shows FPD density detected by this evaluation. As shown in FIG. 1, oxygen concentration dependence was clearly observed in the FPD density, the FPD density is precipitously decreased with a reduction in oxygen concentration with the oxygen concentration 8×10¹⁷ atoms/cm³ (ASTM' 79) at a boundary.

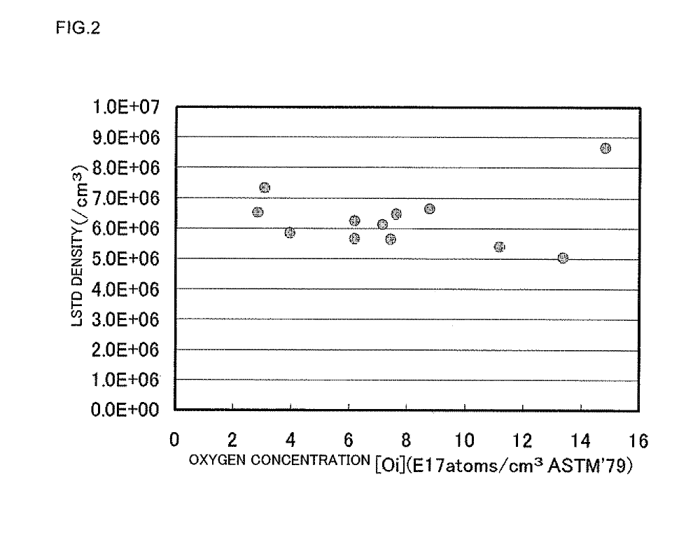

Subsequently, the same sample as that subjected to the FPD evaluation was cleaved, and LSTD density was examined by the infrared scattering method using a laser scattering tomograph (M0441 manufactured by Mitsui Mining And Smelting Company, Limited). FIG. 2 shows its result.

It can be understood that, as compared with the case where the FPD density was precipitously decreased with a reduction in oxygen concentration, the LSTD density is not affected by the oxygen concentration at all.

Since both the FPD and the LSTD are cavities called voids, they are the same type of defect, but it was discovered that there is a defect which is detected as an LSTD but not detected as an FPD. As a cause that this defect can be detected as the LSTD but cannot be detected as the FPD, a small defect size or a change in state of the defect can be considered.

However, according to the infrared scattering method, it is known that scattering intensity reflects a defect size, a tendency that this scattering intensity extremely lowers when the oxygen concentration is reduced is not found, and it is hardly considered that the small defect size is the only cause.

Then, a change in state of a defect can be also considered as one cause. An inner wall oxide film is present in the void. It can be considered that a reduction in oxygen leads to a decrease in thickness of this inner wall oxide film and this decrease advances to annihilation. In regard to the FPD in a D defect region (which corresponds to a vacancy-rich region of CZ) of FZ crystal containing no oxygen, considering a fact that a flow pattern is confirmed but a pit cannot be found, it can be assumed that the inner wall oxide film exercises any effect on FPD detection and cavities are hard to be observed as FPDs due to a reduction in oxygen. On the other hand, since LSTDs are detected by scattering of infrared rays, scattering occurs if there is a difference in conductivity, and hence it can be assumed that LSTDs sensitively respond to cavities and the LSTDs can be detected even though a reduction in oxygen is realized.

Thus, as voids present in the vacancy-rich region, it was confirmed that there is a defect that is detected as the LSTD but not detected as the FPD as oxygen concentration is lowered. As described above, it can be assumed as a cause that a change in status of the inner wall oxide film in each void due to a reduction in oxygen concentration affects detection of this defect. This defect that is detected as the LSTD but not detected as the FPD can be easily observed by combining FPD observation using preferential etching with LSTD observation using infrared scattering.

### Experiment 3

Then, in a region corresponding to a growth rate slightly higher than that in a defect-free region or an OSF region in the defect distribution map of FIG. 16, each crystal having oxygen concentration that is 8×10¹⁷ atoms/cm³ (ASTM' 79) and lower than that was grown, and FPDs and LSTDs were evaluated.

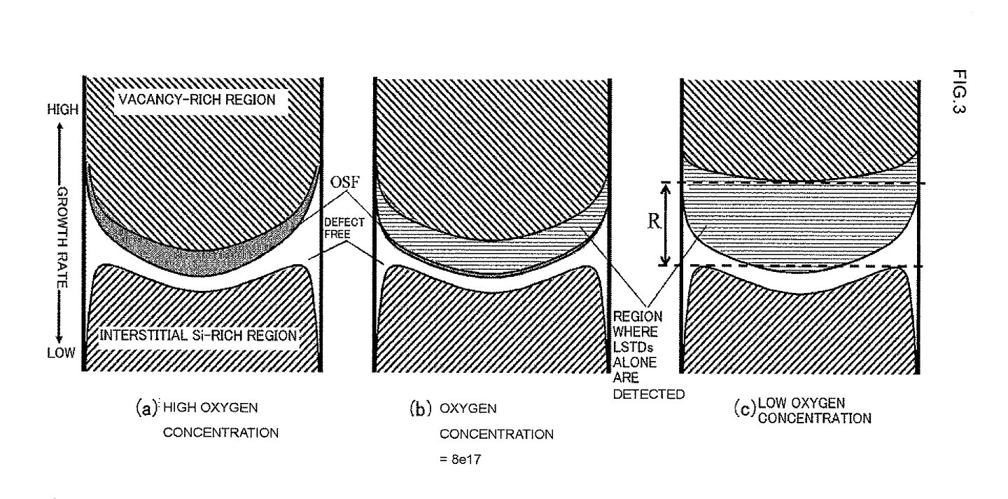

As a result, it was found out that a region where FPDs were not detected at all and LSTDs alone are detected was present. FIG. 3 schematically shows a defect region of crystal at each oxygen concentration. As shown in FIG. 3(b), the region where LSTDs alone are detected started to be produced from crystal having oxygen concentration of 8×10¹⁷ atoms/cm³ (ASTM' 79) and spreads with a reduction in oxygen concentration.

Performing device evaluation with respect to a wafer including this region, it was found out that this region has no problem in breakdown voltage/leak at all. It can be considered that the inner wall oxide film has a greater adverse affect than the void itself on a device. Further, conditions for growing crystal in such a region can be assuredly discovered by the FPD detection and LSTD detection as described above, and their range is wide, thereby improving productivity.

Thus, in case of a wafer including the above-described region at the oxygen concentration of 8×10¹⁷ atoms/cm³ (ASTM' 79) or less, a device failure does not occur even at the low oxygen concentration, manufacture is enabled with good productivity, and hence a cost can be reduced, thereby bringing the present invention to completion.

Furthermore, as shown in a schematic view of FIG. 3, the region where the FPDs are not detected but LSTDs alone are detected is adjacent to a defect-free region where even LSTDs are not observed. Moreover, at an outer peripheral portion of each crystal, since point defects such as vacancies or interstitial Si are outwardly diffused and annihilated, this is also a region where a supersaturation state of the point defects does not occur and a defect-free state is necessarily realized.

Therefore, at the time of actually fabricating a wafer, a wafer having a certain level of defect-free region from a wafer outer peripheral portion toward the inner side can be easily manufactured as compared with a wafer consisting of a region where the LSTDs alone are detected, and the former wafer has good productivity. Additionally, it has no problem of breakdown voltage/leak characteristics in the defect-free region.

Thus, an actually effective wafer is a wafer that is sliced out from a silicon single crystal ingot having oxygen concentration of 8×10¹⁷ atoms/cm³ (ASTM' 79) or less, which is a silicon single crystal wafer consisting of a defect region where neither FPDs nor LEPs are detected by the preferential etching but LSTDs are detected by the infrared scattering method and a defect-free region where LSTDs are not detected by the infrared scattering method.

### Experiment 4

Subsequently, a relationship between oxygen concentration in crystal and an amount of oxygen donor generated at the time of a heat treatment was examined.

In a device, various kinds of impurities are introduced into a wafer, thereby resistivity is controlled, and a PN junction or the like is formed. At this time, if the resistivity of the wafer is unstable, a problem may possibly occur in a device operation. In case of a wafer sliced out from CZ crystal containing oxygen, an oxygen donor is generated due to a low-temperature heat treatment, and the resistivity of the wafer varies. In conventional examples, in each device using a wafer containing no oxygen, e.g., an EPW (an epitaxial wafer) or an FZ-PW (a polished wafer), such an oxygen donor may possibly exercise an adverse effect.

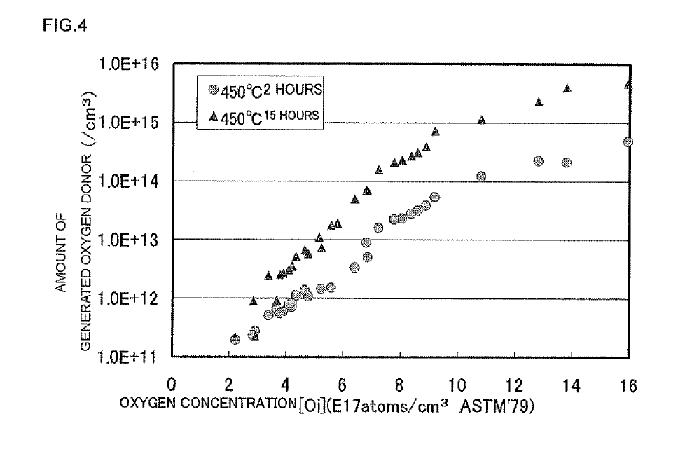

Thus, each sample in which oxygen concentration was designated in CZ crystal was prepared, and an amount of carriers generated due to the oxygen donor was obtained. First, in each sample, an oxygen donor killer treatment was performed, then resistivity was measured, and a heat treatment having a temperature of 450° C. at which the oxygen donor is apt to be formed was performed for 2 hours or 15 hours. Subsequently, the resistivity after the heat treatment was measured, and the amount of carriers generated by the heat treatment was calculated from a difference from the resistivity before the heat treatment. As a result, such a relationship between the oxygen concentration and the amount of generated carriers as shown in FIG. 4 was obtained.

As shown in FIG. 4, if the oxygen concentration is 8×10¹⁷ atoms/cm³ (ASTM' 79) or less, an amount of generated oxygen donor is small and, in particular, an amount of carriers generated by the heat treatment performed at 450° C. for 15 hours is approximately 7×10¹²/cm³ in a sample having the oxygen concentration of 5×10¹⁷ atoms/cm³ (ASTM' 79). This concentration corresponds to approximately 1900 Ωcm in case of a P type or approximately 600 Ωcm in case of an N type, the concentration is usually more than one digit different from that in the range applied to a device, and no problem occurs even if this amount of carriers is generated.

Therefore, if the oxygen concentration is 5×10¹⁷ atoms/cm³ (ASTM' 79) or less, an amount of oxygen donor to be generated is small, and it can be said that the resistivity hardly varies. In an actual device process, considering that a heat environment corresponding to 450° C. is hardly applied for 15 hours and a process of approximately 2 hours is close to the reality, the amount of generated carries is approximately 1.5×10¹² atoms/cm³ which is further one digit smaller than the above amount, and it can be conceived that the resistivity does not vary at all.

Further, when the oxygen concentration is lowered, the region where the FPDs are not detected but the LSTDs alone are detected tends to expand as described above, and a margin for manufacture enlarges.

Thus, it was discovered that a wafer sliced out from a silicon single crystal ingot having the above-described defect region according to the present invention and oxygen concentration of 8×10¹⁷ atoms/cm³ (ASTM' 79) or less, especially 5×10¹⁷ atoms/cm³ (ASTM' 79) or less is preferable.

### Experiment 5

Then, a relationship between nitrogen concentration and oxygen concentration for doping to crystal was examined.

When nitrogen was doped to the crystal, each void becomes small. That is because nitrogen and each vacancy are paired, effective vacancy concentration is lowered to decrease a degree of supersaturation, and a void forming temperature is reduced. A region where FPDs are not detected but LSTDs alone are detected had a tendency to expand due to nitrogen doping. However, when nitrogen is doped, an NO donor having nitrogen and oxygen combined with each other is generated. Although the NO donor is annihilated by a heat treatment performed at approximately 900° C. or more, it may possibly remain due to a low temperature in a recent device process, and excessively doping nitrogen is not preferable.

Thus, a sample of crystal having designated oxygen concentration and designated nitrogen concentration was prepared, and an amount of generated NO donor was obtained.

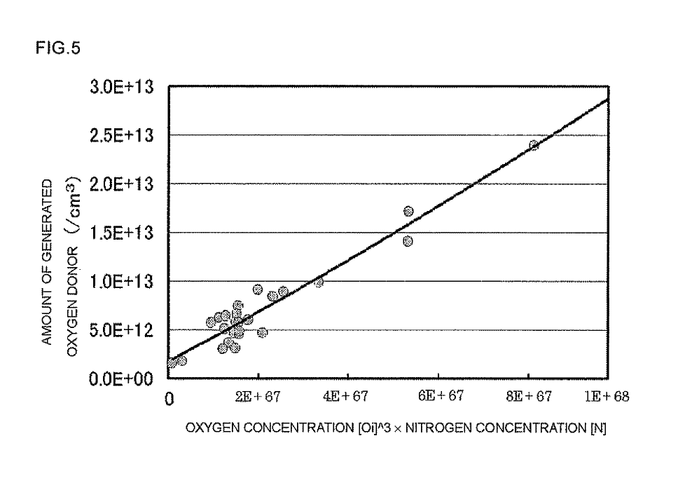

First, a regular oxygen donor killer treatment was performed, and then resistivity of the sample was measured. Subsequently, a heat treatment was performed at 1000° C. for 16 hours so as to assuredly annihilate the NO donor, then the resistivity was again measured, and an amount of carriers generated due to the NO donor was obtained. As a result, the amount of carriers generated due to the NO donor is dependent on both the oxygen concentration and the nitrogen concentration, and such a relationship as shown in FIG. 5 that is dependent on a product of the nitrogen concentration to the first power and the oxygen concentration to the third power was obtained as a result of fitting. FIG. 5 is a graph showing a relationship between a product of the nitrogen concentration to the first power and the oxygen concentration to the third power and the amount of carriers generated due to the NO donor. Like the oxygen donor, it was discovered that, when an allowable range for the amount of carriers generated due to the NO donor is set to 1×10¹³/cm³ or less, it is preferable to provide a silicon single crystal wafer containing nitrogen and oxygen in such a manner that the nitrogen concentration [N] atoms/cm³ and the oxygen concentration [Oi] atoms/cm³ (ASTM' 79) meet [N]×[Oi]³≦5.3.5×10⁶⁷.

The present inventors brought the present invention described below to completion based on the above-mentioned experiments.

An embodiment of the present invention will now be described hereinafter in detail with reference to the drawings, but the present invention is not restricted thereto.

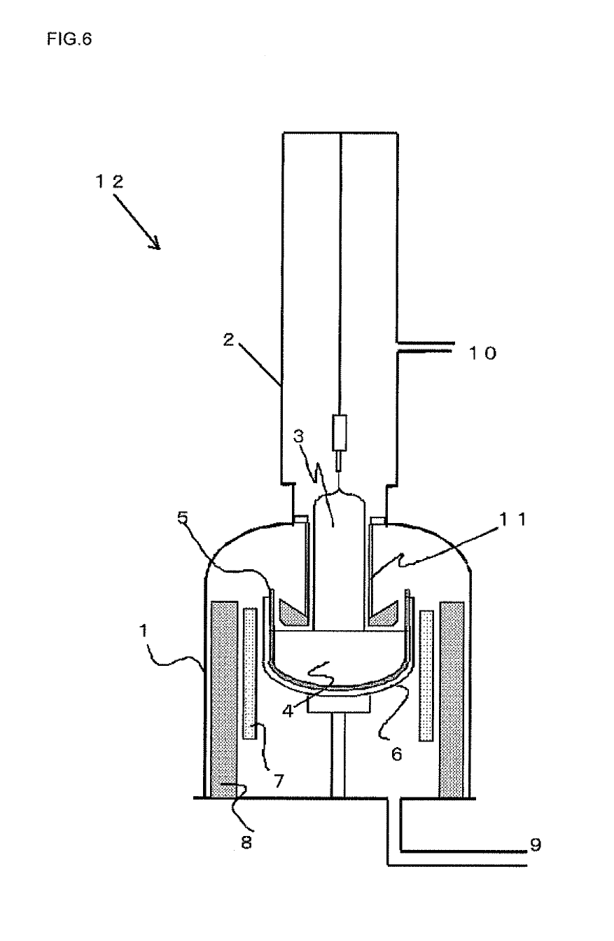

According to a manufacturing method of the present invention, first, a silicon single crystal pulling apparatus shown in, e.g., FIG. 6 is used, and a silicon single crystal ingot is grown based on the Czochralski method. FIG. 6 is a schematic view of the silicon single crystal pulling apparatus.

The single-crystal pulling apparatus that can be used for the manufacturing method according to the present invention will now be described.

The single-crystal pulling apparatus 12 in FIG. 6 is constituted of a main chamber 1, a quartz crucible 5 and a graphite crucible 6 that accommodate a raw material melt 4 in the main chamber 1, a heater 7 arranged around the quartz crucible 5 and the graphite crucible 6, an insulating material 8 surrounding the outer side of the heater 7, and a pulling chamber 2 disposed to the upper side of the main chamber 1. A gas introducing opening 10 through which a gas to be circulated in a furnace is introduced is provided to the pulling chamber 2, and a gas outlet opening 9 through which the gas circulated in the furnace is discharged is provided to a bottom portion of the main chamber 1.

Further, as shown in FIG. 6, an annular gas flow-guide cylinder (a graphite cylinder) 11 can be provided in accordance with manufacturing conditions. Furthermore, it is possible to use an apparatus adopting a so-called MCZ method by which magnets (not shown) are disposed on the outer side of the main chamber 1 and a horizontal or vertical magnetic field is applied to the raw material melt 4 whereby a convection current of the melt can be suppressed and single crystal can be stably grown.

In the present invention, the respective parts in the apparatus that are the same as those in the conventional examples can be used.

An example of a single-crystal growth method using the above-described single crystal pulling apparatus 12 will now be described.

First, a high-purity polycrystalline raw material of silicon is heated to a melting point (approximately 1420° C.) or more and molten in the quartz crucible 5, thereby obtaining a raw material melt 4. Then, an end of seed crystal is brought into contact with or immersed in a substantially central part of a surface of the raw material melt 4 by winding off a wire. Thereafter, the quartz crucible 5 and the graphite crucible 6 are rotated in an appropriate direction, the wire is wound up while rotating, and the seed crystal is pulled up, thus starting growth of a silicon single crystal ingot 3.

Subsequently, a pulling rate and a temperature are appropriately adjusted so as to form a defect region of the present invention, and the substantially cylindrical silicon single crystal ingot 3 is obtained. The quartz crucible 5 and the graphite crucible 6 can be moved up and down along a crystal growth axis direction, and the quartz crucible 5 and the graphite crucible 6 are moved up to compensate a descent of a liquid level of the raw material melt 4 reduced by crystallization during the crystal growth. As a result, a height of the surface of the raw material melt 4 is controlled to a substantially fixed desired height.

At the time of such pulling, in the present invention, the pulling rate and the temperature are controlled so as to have oxygen concentration (initial interstitial oxygen concentration) of 8×10¹⁷ atoms/cm³ (ASTM' 79) or less in the silicon single crystal ingot and include a defect region where neither FPDs nor LEPs are detected by preferential etching but LSTDs are detected by the infrared scattering method.

As a method for efficiently controlling the pulling rate (a growth rate) so as to include the defect region according to the present invention, for example, obtaining conditions for forming the defect region according to the present invention by a preliminary test in advance is preferable.

In this case, a vacancy-rich region can be obtained as a region where FPDs are detected by the preferential etching, and an interstitial Si-rich region can be obtained as a region where LEPs are detected. Furthermore, the defect region according to the present invention is a defect region where neither FPDs nor LEPs are detected by the preferential etching but LSTDs are detected by the infrared scattering method (a region where LSTDs alone are detected). Moreover, a region where defects are not detected by any method is a defect-free region. Therefore, in regard to crystal pulled by a preliminary test, such defect distributions as shown in FIGS. 3(b) and 3(c) can be obtained by using the infrared scattering method and the preferential etching, and pulling conditions can be set.

Then, based on the obtained relationship, the pulling rate is controlled to fall within, e.g., a range R shown in FIG. 3(c), and then the crystal is pulled and processed into a wafer. At this time, the silicon single crystal ingot can be grown so as to include the defect region where neither FPDs nor LEPs are detected by the preferential etching but LSTDs are detected by the infrared scattering method.

At this time, although the silicon single crystal ingot including the defect region according to the present invention can be grown on any side of a high-rate side and a low-rate side of the range R in FIG. 3(c), it is preferable to grow the silicon single crystal ingot including the defect region where neither the FPDs nor LEPs are detected by the preferential etching but LSTDs are detected by the infrared scattering method and the defect-free region by controlling the pulling rate within the range R.

Since FPDs are generated at a central part of a wafer to be sliced out in case of the high-rate side of the range R in FIG. 3(c) and LEPs are generated at an outer periphery of the wafer to be sliced out in case of the low-rate side of the same, a device failure may possibly occur in a portion where the FPDs or the LEPs are generated. Therefore, when the silicon single crystal ingot including the defect-free region and the defect region according to the present invention is grown, it is possible to obtain a wafer to be sliced out which has no device failure occurring at any portion thereof and can improve a yield ratio.

Additionally, as a method for setting the oxygen concentration in the silicon single crystal ingot to 8×10¹⁷ atoms/cm³ (ASTM' 79) or less, a general method can be used, and the oxygen concentration falling within the above-described range can be obtained by applying a magnetic field, controlling rotation of the crystal, rotation of the crucibles, or the pulling rate.

When such oxygen concentration is obtained, the defect region where neither FPDs nor LEPs are not detected by the preferential etching but LSTDs are detected by the infrared scattering method can be generated, and the silicon single crystal wafer according to the present invention can be manufactured. Further, when such low oxygen concentration is obtained, since oxygen is hardly precipitated, a wafer in which defects such as BMDs are not generated and a device failure does not occur can be obtained.

Furthermore, it is preferable to set this oxygen concentration to 5×10¹⁷ atoms/cm³ (ASTM' 79) or less.

As obvious from Experiment 4, if the oxygen concentration is 5×10¹⁷ atoms/cm³ (ASTM' 79) or less, an amount of the oxygen donor generated by a device heat treatment or the like is sufficiently small, and the resistivity hardly varies, which is preferable. Moreover, when the oxygen concentration is lower, the defect region where neither the FPDs nor LEPs are detected by the preferential etching but LSTDs are detected by the infrared scattering method can spread, and hence a margin for manufacture can expand, thereby reducing costs.

Additionally, it is preferable to grow the silicon single crystal ingot so as to contain nitrogen and oxygen so that the nitrogen concentration [N] atoms/cm³ and the oxygen concentration [Oi] atoms/cm³ (ASTM' 79) can meet [N]×[Oi]³≦3.5×10⁶⁷.

When nitrogen is doped in this manner, defect size becomes small, and the defect region according to the present invention further spreads, thereby further improving the productivity. Furthermore, as shown in Experiment 5 and FIG. 5, when the nitrogen concentration and the oxygen concentration meet the above-described relationship, generation of the NO donor at the time of a device heat treatment is sufficiently reduced, and a fluctuation in resistivity of the wafer can be suppressed so that a device cannot be affected.

The silicon single crystal ingot grown as described above is sliced and subjected to lapping, chamfering, polishing, etching, and others, thereby fabricating each silicon single crystal wafer.

If the above-described silicon single crystal wafer is provided, the high-quality wafer which does not have a breakdown voltage failure or a leak failure of a fabricated device occurring therein and is suitable for a power device can be obtained at low cost.

### EXAMPLES

Although the present invention will now be more specifically explained with reference to examples and a comparative example, the present invention is not restricted thereto.

### Example 1

Such a single-crystal pulling apparatus as shown in FIG. 6 was used, a crucible having a diameter of 26 inches (66 cm) was placed in a furnace, and a silicon single crystal ingot was grown by a magnetic field applying Czochralski method (an MCZ method).

At this time, the silicon single crystal ingot having a size that allows a wafer to have a finish diameter of 200 mm was grown aiming at oxygen concentration [Oi] 7×10¹⁷ atoms/cm³ (ASTM' 79) and also aiming at a region shown in FIG. 3(c) where FPDs and LEPs are not detected but LSTDs are detected.

A wafer-shaped sample was sliced from the grown crystal, and FPDs/LEPs were observed by a method using such preferential etching explained in Experiments 1 and 2, but these defects were not detected. Further, the wafer-shaped sample sliced out from the same position was subjected to surface grinding, cleaning, and mirror etching using a mixed acid, and then it was subjected to a heat treatment in a wet oxidizing atmosphere at 1150° C. for 100 minutes. Subsequently, the sample etched with a removal of 7±3 μm on both sides by using an etchant with selectivity consisting of, e.g., a hydrofluoric acid, a nitric acid, an acetic acid, and water while shaking was observed with use of an optical microscope, and it was confirmed that OSFs did not occur.

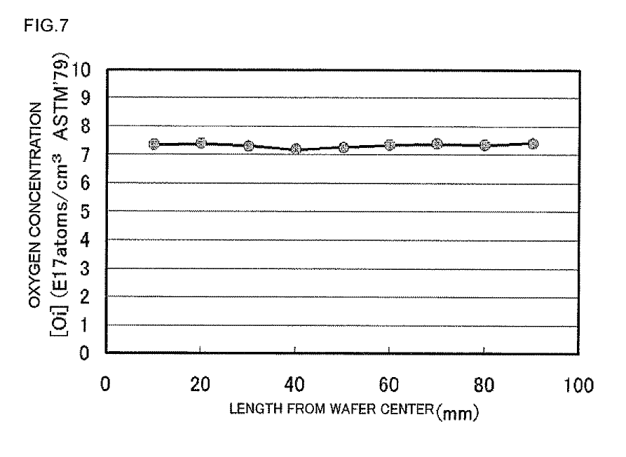

As shown in FIG. 7, a radial distribution of oxygen concentration of this sample was in the range of 7.2×10¹⁷ to 7.4×10¹⁷ atoms/cm³ (ASTM' 79).

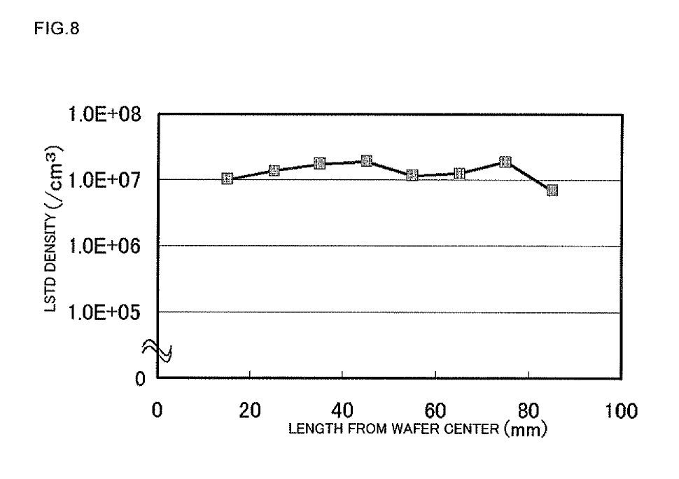

Furthermore, infrared rays incident on the surface by using an infrared scattering tomograph (MO441), and scattered light was observed from a cleavage plane to obtain LSTD density. As a result, an LSTD radial distribution corresponds to density which is approximately 1×10⁷/cm³ on the entire wafer surface as shown in FIG. 8.

Based on the above-described evaluation, the sample was sliced out from the silicon single crystal ingot having the oxygen concentration of 8×10¹⁷ atoms/cm³ (ASTM' 79) or less, and it was confirmed that the defect region where neither FPDs nor LEPs were detected by the preferential etching but LSTDs were detected by the infrared scattering method.

A wafer sliced out from a portion adjacent to this evaluated sample was subjected to a regular wafer processing treatment such as chamfering, lapping, polishing, and others, and thereby it was finished into a polished wafer (PW). When this PW was used as a substrate and a power device was fabricated, a normal device operation was performed without causing a breakdown voltage failure, a leak failure, and others.

### Example 2

Crystal was grown in the same manner as Example 1 except that target oxygen concentration of a silicon single crystal ingot to be grown was reduced to 3×10¹⁷ atoms/cm³ and a growth rate was slightly adjusted.

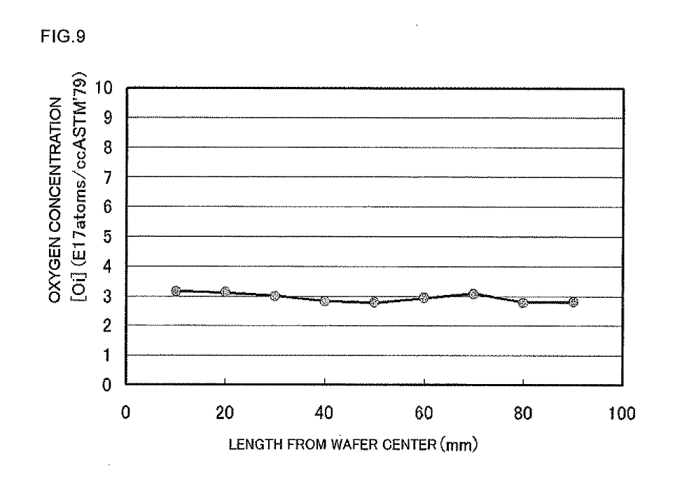

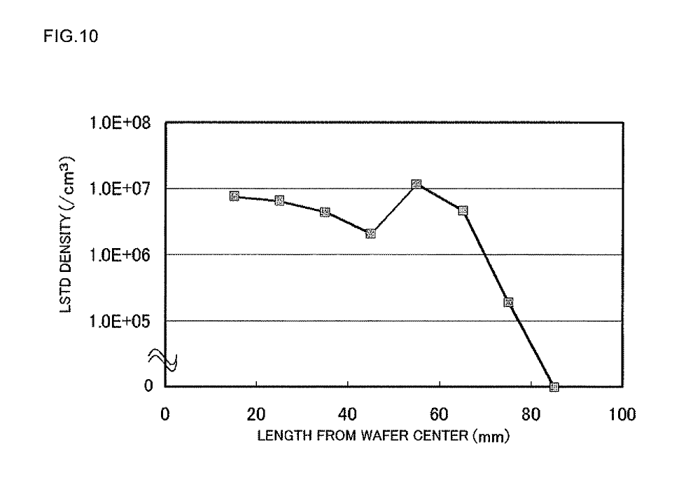

The same evaluation as that in Example 1 was conducted, but FPDs, LEPs, and OSFs were not detected. Moreover, in regard to oxygen concentration and an LSTD radial distribution, as shown in FIGS. 9 and 10, the oxygen concentration was in the range of 2.8×10¹⁷ to 3.2×10¹⁷ atoms/cm³ (ASTM' 79), the highest value of the LSTD density was 1.2×10⁷/cm³, and LSTDs were not detected at a peripheral portion.

Based on the above-described evaluation, the wafer was sliced out from the silicon single crystal ingot having the oxygen concentration of 8×10¹⁷ atoms/cm³ (ASTM' 79) or less, and it was confirmed that the wafer consists of the defect region where neither FPDs nor LEPs are detected by the preferential etching but LSTDs are detected by the infrared scattering method and the defect-free region at the peripheral portion.

When a PW was fabricated from a portion adjacent to this evaluated sample and a power device was fabricated thereon, a normal device operation was performed without causing a breakdown voltage failure, a leak failure, and others and without a resistivity shift due to a donor.

### Comparative Example

Although target oxygen concentration was the same as that in Example 2, a growth rate was sufficiently increased as compared with Example 2, and crystal was grown so as to obtain a region where FPDs are detected.

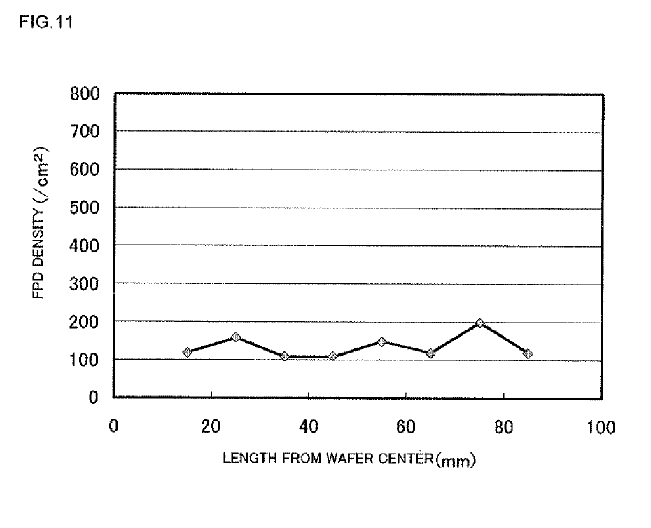

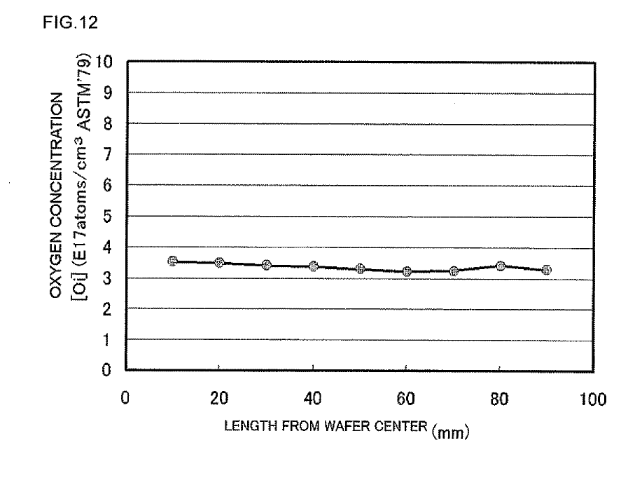

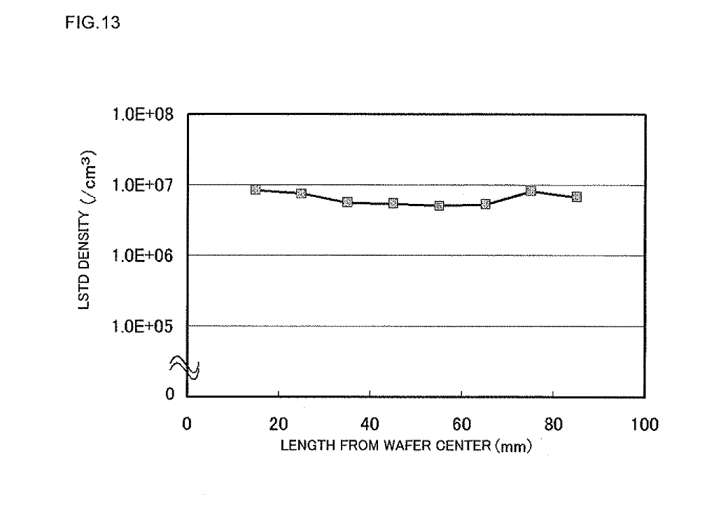

The same evaluation as that in Example 1 was conducted, and LEPs and OSFs were not detected, but 100 to 200 (pieces/cm²) FPDs were detected as shown in FIG. 11. In regard to oxygen concentration and an LSTD radial distribution, as shown in FIGS. 12 and 13, the oxygen concentration was in the range of 3.2×10¹⁷ to 3.5×10¹⁷ atoms/cm³ (ASTM' 79), the LSTD density was in the range of 5×10⁶ to 9×10⁶/cm³, and LSTDs were approximately evenly distributed in the entire plane.

When a PW was fabricated from a portion adjacent to this evaluated sample and a power device was fabricated thereon. As a result, a failure rate which is considered to be caused by leak was increased to be triple or quintuple as compared with that according to Example 2, thereby leading to a reduction a yield ratio.

### Example 3

Crystal was grown under completely the same conditions except that nitrogen was doped so that nitrogen concentration in the crystal can be 6×10¹³ atoms/cm³ at a position where a wafer-shaped sample was sliced out.

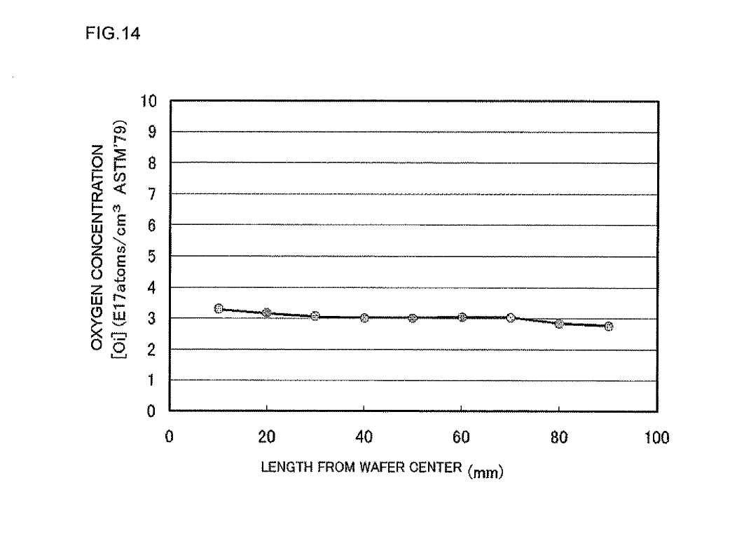

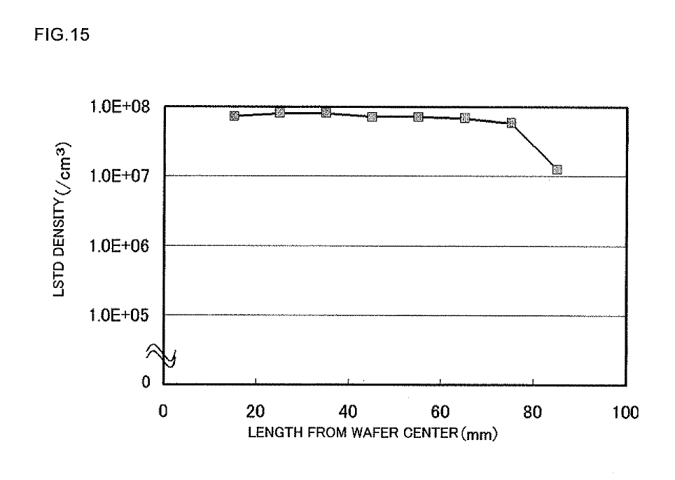

The same evaluation as that in Example 1 was conducted, but FPDs, LEPs, and OSFs were not detected. A radial distribution of oxygen concentration was 2.8×10¹⁷ to 3.3×10¹⁷ atoms/cm³ (ASTM' 79) as shown in FIG. 14, and a relationship between the oxygen concentration and nitrogen concentration was [N]×[Oi]³≦2.2×10⁶⁶. Moreover, as a radial distribution of ISTD density, high density that was approximately 7×10⁷/cm³ was obtained as shown in FIG. 15.

When a PW was fabricated from a portion adjacent to this evaluated sample and a power device was fabricated thereon, a normal device operation was performed without causing a breakdown voltage failure, a leak failure, and others but with a small resistivity shift due to a donor.

It is to be noted that the evaluation results obtained by Examples 1 to 3 and Comparative Example concern the power device to which a high voltage is applied, but it can be easily assumed that the defect region according to the present invention has no problem of a breakdown voltage or leak even in any other device such as a memory, a CPU, or an imaging device that operates at a lower voltage, and hence the present invention is not the technology restricted to a power device substrate.

The present invention is not restricted to the foregoing embodiment. The foregoing embodiment is just an illustrative example, and any example that has substantially the same configuration and exercises the same functions and effects as the technical concept described in claims according to the present invention is included in the technical scope of the present invention.

1-4. (canceled)

5. A silicon single crystal wafer sliced out from a silicon single crystal ingot grown by a Czochralski method, wherein the silicon single crystal wafer is sliced out from the silicon single crystal ingot having oxygen concentration of 8×10¹⁷ atoms/cm³ (ASTM' 79) or less and comprises a defect region where neither FPDs nor LEPs are detected by preferential etching but LSTDs are detected by an infrared scattering method.

6. The silicon single crystal wafer according to claim 5, wherein the silicon single crystal wafer consists of: a defect region where neither FPDs nor LEPs are detected by the preferential etching but LSTDs are detected by the infrared scattering method; and a defect-free region where LSTDs are not detected by the infrared scattering method.

7. The silicon single crystal wafer according to claim 5, wherein the silicon single crystal wafer is sliced out from the silicon single crystal ingot having oxygen concentration of 5×10¹⁷ atoms/cm³ (ASTM' 79) or less.

8. The silicon single crystal wafer according to claim 6, wherein the silicon single crystal wafer is sliced out from the silicon single crystal ingot having oxygen concentration of 5×10¹⁷ atoms/cm³ (ASTM' 79) or less.

9. The silicon single crystal wafer according to claim 5, wherein the silicon single crystal ingot contains nitrogen and oxygen in such a manner that nitrogen concentration [N] atoms/cm³ and the oxygen concentration [Oi] atoms/cm³ (ASTM' 79) meet [N]×[Oi]³≦3.5×10⁶⁷.

10. The silicon single crystal wafer according to claim 6, wherein the silicon single crystal ingot contains nitrogen and oxygen in such a manner that nitrogen concentration [N] atoms/cm³ and the oxygen concentration [Oi] atoms/cm³ (ASTM' 79) meet [N]×[Oi]³≦3.5×10⁶⁷.

11. The silicon single crystal wafer according to claim 7, wherein the silicon single crystal ingot contains nitrogen and oxygen in such a manner that nitrogen concentration [N] atoms/cm³ and the oxygen concentration [Oi] atoms/cm³ (ASTM' 79) meet [N]×[Oi]³≦3.5×10⁶⁷.

12. The silicon single crystal wafer according to claim 8, wherein the silicon single crystal ingot contains nitrogen and oxygen in such a manner that nitrogen concentration [N] atoms/cm³ and the oxygen concentration [Oi] atoms/cm³ (ASTM' 79) meet [N]×[Oi]³≦3.5×10⁶⁷.
